(19) United States
(12) Patent Application Publication
(10) Pub. No.: US 2017/0169355 A1
(43) Pub. Date: Jun. 15, 2017

(54) Ground Truth Improvement Via Machine Learned Similar Passage Detection

(71) Applicant: International Business Machines Corporation, Armonk, NY (US)

(72) Inventors: John M. Boyer, Victoria (CA); Kshitij P. Fadnis, Dublin, OH (US); Collin J. Murray, Lynnfield, MA (US); Justin A. Ziniel, Columbus, OH (US)

(21) Appl. No.: 14/966,802

(22) Filed: Dec. 11, 2015

(51) Int. Cl. G06N 99/00; G06N 5/02

(52) U.S. Cl. CPC G06N 99/005; G06N 5/02

(57) ABSTRACT

A mechanism is provided in a data processing system to improve ground truth in a question answering cognitive system. The mechanism trains a similar passage machine learning model for a similar passage cognitive system using a question and answer key to form a trained similar passage machine learning model. The question and answer key comprises a list of question and answer specification pairs forming a ground truth for the question answering cognitive system. Each question is a text string and each answer specification references one or more text passages from a corpus of information. Responsive to a search event, the mechanism sends at least one text input to the similar passage cognitive system operating in accordance with the trained similar passage machine learning model, wherein the text input comprises a given question text string or a given text passage from the question and answer key, and receives from the similar passage cognitive system a response list of references to text passages from the corpus of information. Responsive to an answer acceptance event for at least one text passage from the response list, the mechanism supplements the question and answer key with the at least one text passage to form a supplemented question and answer key. The mechanism trains a question answering machine learning model of the data processing system using the supplemented question and answer key such that the question answering cognitive system operates in accordance with the trained question answering machine learning model.

### BACKGROUND

The present application relates generally to an improved data processing apparatus and method and more specifically to mechanisms for improving a ground truth answer key of a question answering cognitive system using a similar passage cognitive system trained with a ground truth answer key from the question answering cognitive system.

With the increased usage of computing networks, such as the Internet, humans are currently inundated and overwhelmed with the amount of information available to them from various structured and unstructured sources. However, information gaps abound as users try to piece together what they can find that they believe to be relevant during searches for information on various subjects. To assist with such searches, recent research has been directed to generating question answering (QA) systems which may take an input question, analyze it, and return results indicative of the most probable answers to the input question. QA systems provide automated mechanisms for searching through a large corpus of information, i.e. large sets of sources of content such as electronic documents, and analyze the content with regard to an input question to determine answers to the question and a confidence measure per answer indicating the probability that it is a useful answer for the input question.

Examples, of QA systems are Siri® from Apple®, Cortana® from Microsoft® , and the IBM Watson™ system available from International Business Machines (IBM®) Corporation of Armonk, New York. The IBM Watson™ system is an application of advanced natural language processing, information retrieval, knowledge representation and reasoning, and machine learning technologies to the field of question answering. The IBM Watson™ system is built on IBM's DeepQA™ technology used for hypothesis generation, massive evidence gathering, analysis, and scoring, DeepQA™ takes an input question, analyzes it, decomposes the question into constituent parts, generates one or more hypothesis based on the decomposed question and results of a primary search of answer sources, performs hypothesis and evidence scoring based on a retrieval of evidence from evidence sources, performs synthesis of the one or more hypotheses, and based on trained models, performs a final merging and ranking to output an answer to the input question along with a confidence measure,

### SUMMARY

In one illustrative embodiment, a method is provided in a data processing system comprising at least one processor and a memory comprising instructions which, when executed by the at least one processor, causes the at least one processor to improve ground truth in a question answering cognitive system. The method comprises training a similar passage machine learning model for a similar passage cognitive system using a question and answer key to form a trained similar passage machine learning model. The question and answer key comprises a list of question and answer specification pairs forming a ground truth for the question answering cognitive system, wherein each question is a text string and each answer specification references one or more text passages from a corpus of information. The method further comprises sending, responsive to a search event, at least one text input to the similar passage cognitive system operating in accordance with the trained similar passage machine learning model, wherein the text input comprises a given question text string or a given text passage from the question and answer key, and receiving from the similar passage cognitive system a response list of references to text passages from the corpus of information. The method further comprises supplementing, responsive to an answer acceptance event for at least one text passage from the response list, the question and answer key with the at least one text passage to form a supplemented question and answer key. The method further comprises training a question answering machine learning model of the data processing system using the supplemented question and answer key such that the question answering cognitive system operates in accordance with the trained question answering machine learning model.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE SEVERAL VIEWS OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 depicts a schematic diagram of one illustrative embodiment of a cognitive system in a computer network;

FIG. 2 is a block diagram of an example data processing system in which aspects of the illustrative embodiments are implemented;

FIG. 3 illustrates a QA system pipeline for processing an input question in accordance with one illustrative embodiment;

FIG. 4A illustrates, using a single linguistic scorer, the training effect of a ground truth question and answer key on linguistic training of a machine learning model as well as the usage effect the machine learning model on relating linguistic scores to answer confidence in accordance with an illustrative embodiment;

FIG. 4B illustrates a machine learning model that is poorly trained due to having some passages incorrectly omitted from the ground truth question and answer key in accordance with an illustrative embodiment;

FIG. 5A illustrates an example of a question and passage list answer key in accordance with an illustrative embodiment;

FIG. 5B shows an example of passages collected for each question in accordance with the illustrative embodiment;

FIG. 5C shows an example of new passages that should be in ground truth in accordance with the illustrative embodiment;

FIG. 6 is a flowchart illustrating operation of a mechanism for using a similar passage cognitive system to improve ground truth of a question answering cognitive system in accordance with an illustrative embodiment; and

FIG. 7 is a flowchart illustrating operation of a mechanism for supplementing ground truth based on subject matter expert markings in accordance with an illustrative embodiment.

### DETAILED DESCRIPTION

The illustrative embodiments provide mechanisms for ground truth improvement via machine learned similar passage detection. A cognitive question answering system, or QA system, is defined here to be a computer system that receives a question in natural language or query format and returns an answer or answers extracted from a corpus of information, such as natural language documents. Because a corpus contains answers for many questions, the quality of the QA system is a function of its ability to provide answers that are more relevant to questions given and to suppress providing answers that are less relevant, to the questions given.

A QA system is a cognitive system operating in accordance with a question answering machine learning model. A subject matter expert (SME) initially provides ground truth in the form of a question and answer key, which comprises a plurality of questions each having an associated answer specification such as a list of answer indicators. The answer key is then used to train the QA machine learning model; therefore, a more complete question and answer key results in a more robust and accurate machine learning model, which in turn results in a more effective QA system.

Before beginning the discussion of the various aspects of the illustrative embodiments in more detail, it should first be appreciated that throughout this description the term “mechanism” will be used to refer to elements of the present invention that perform various operations, functions, and the like. A “mechanism,” as the term is used herein, may be an implementation of the functions or aspects of the illustrative embodiments in the form of an apparatus, a procedure, or a computer program product. In the case of a procedure, the procedure is implemented by one or more devices, apparatus, computers, data processing systems, or the like. In the case of a computer program product, the logic represented by computer code or instructions embodied in or on the computer program product is executed by one or more hardware devices in order to implement the functionality or perform the operations associated with the specific “mechanism.” Thus, the mechanisms described herein may be implemented as specialized hardware, software executing on general purpose hardware, software instructions stored on a medium such that the instructions are readily executable by specialized or general purpose hardware, a procedure or method for executing the functions, or a combination of any of the above.

The present description and claims may make use of the terms “a”, “at least one of”, and “one or more of” with regard to particular features and elements of the illustrative embodiments. It should be appreciated that these terms and phrases are intended to state that there is at least one of the particular feature or element present in the particular illustrative embodiment, but that more than one can also he present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims.

In addition, it should be appreciated that the following description uses a plurality of various examples for various elements of the illustrative embodiments to further illustrate example implementations of the illustrative embodiments and to aid in the understanding of the mechanisms of the illustrative embodiments. ‘These examples intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the examples provided herein without departing from the spirit and scope of the present invention.

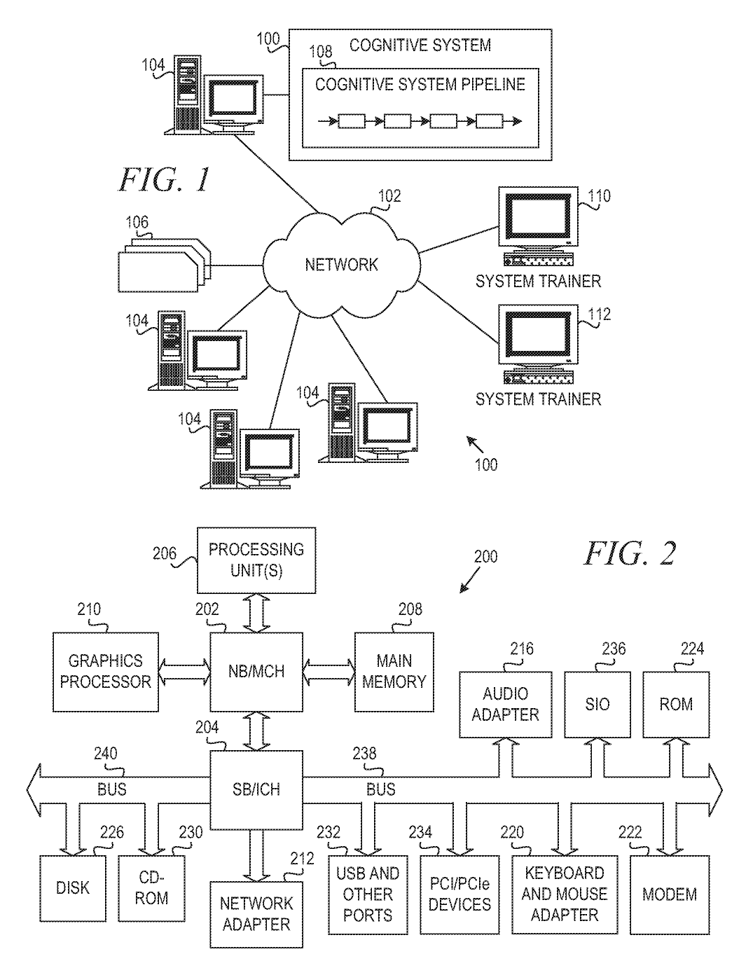

The illustrative embodiments may be utilized in many different types of data processing environments. In order to provide a context for the description of the specific elements and functionality of the illustrative embodiments, FIGS. 1-3 are provided hereafter as example environments in which aspects of the illustrative embodiments may be implemented. It should be appreciated that FIGS. 1-3 are only examples and are not intended to assert or imply any limitation with regard to the environments in which aspects or embodiments of the present invention may be implemented. Many modifications to the depicted environments may be made without departing from the spirit and scope of the present invention.

FIGS. 1-3 are directed to describing an example cognitive system, such as a Question Answering (QA) system (also referred to as a Question/Answer system or Question and Answer system), methodology, and computer program product with which the mechanisms of the illustrative embodiments are implemented. As will be discussed in greater detail hereafter, the illustrative embodiments are integrated in, augment, and extend the functionality of these cognitive mechanisms with regard to for improving a ground truth answer key of a question answering cognitive system using a similar passage cognitive system trained with a ground truth answer key from the question answering cognitive system.

Thus, it is important to first have an understanding of how question and answer creation in a cognitive system, such as a QA system, is implemented before describing how the mechanisms of the illustrative embodiments are integrated in and augment such QA systems. It should be appreciated that the cognitive mechanisms described in FIGS. 1-3 are only examples and are not intended to state or imply any limitation with regard to the type of cognitive mechanisms with which the illustrative embodiments are implemented. Many modifications to the example cognitive system shown in FIGS. 1-3 may be implemented in various embodiments of the present invention without departing from the spirit and scope of the present invention.

As an overview, a Question Answering cognitive system (QA system) is an artificial intelligence application executing on data processing hardware that answers questions pertaining to a given subject-matter domain presented in natural language. The QA system is a cognitive system operating in accordance with a QA machine learning model. The QA system receives inputs from various sources including input over a network, a corpus of electronic documents or other data, data from a content creator, information from one or more content users, and other such inputs from other possible sources of input. Data storage devices store the corpus of information. A content creator creates content in a document for use as part of a corpus of information with the QA system. The document may include any file, text, article, or source of data for use in the QA system. For example, a QA system accesses a body of knowledge about the domain, or subject matter area, e.g., financial domain, medical domain, legal domain, etc., where the body of knowledge (knowledge base) can be organized in a variety of configurations, e.g., a structured repository of domain-specific information, such as ontologies, or unstructured data related to the domain, or a collection of natural language documents about the domain

In some embodiments, a Similar Passage cognitive system (SP system) is an artificial intelligence application executing on data processing hardware that provides similar passages pertaining to a given subject-matter domain presented in natural language. The SP system is a cognitive system operating in accordance with an SP machine learning model.

Content users input questions to the QA system which then answers the input questions using the content in the corpus of information by evaluating documents, sections of documents, portions of data in the corpus, or the like. When a process evaluates a given section of a document for semantic content, the process can use a variety of conventions to query such document from the QA system, e.g., sending the query to the QA system as a well-formed question which are then interpreted by the QA system and a response is provided containing one or more answers to the question. Semantic content is content based on the relation between signifiers, such as words, phrases, signs, and symbols, and what they stand for, their denotation, or connotation. In other words, semantic content is content that interprets an expression, such as by using Natural Language Processing.

As will be described in greater detail hereafter, the QA system receives an input question, parses the question to extract the major features of the question, uses the extracted features to formulate queries, and then applies those queries to the corpus of information. Based on the application of the queries to the corpus of information, the QA system generates a set of hypotheses, or candidate answers to the input question, by looking across the corpus of information for portions of the corpus of information that have some potential for containing a valuable response to the input question. The QA system then performs deep analysis on the language of the input question and the language used in each of the portions of the corpus of information found during the application of the queries using a variety of reasoning algorithms. There may be hundreds or even thousands of reasoning algorithms applied, each of which performs different analysis, e.g., comparisons, natural language analysis, lexical analysis, or the like, and generates a score. For example, some reasoning algorithms may look at the matching of terms and synonyms within the language of the input question and the found portions of the corpus of information. Other reasoning algorithms may look at temporal or spatial features in the language, while others may evaluate the source of the portion of the corpus of information and evaluate its veracity.

The scores obtained from the various reasoning algorithms indicate the extent to which the potential response is inferred by the input question based on the specific area of focus of that reasoning algorithm. Each resulting score is then weighted against a statistical model. The statistical model captures how well the reasoning algorithm performed at establishing the inference between two similar passages for a particular domain during the training period of the QA system. The statistical model is used to summarize a level of confidence that the QA system has regarding the evidence that the potential response, i.e. candidate answer, is inferred by the question. This process is repeated for each of the candidate answers until the QA system identifies candidate answers that surface as being significantly stronger than others and thus, generates a final answer, or ranked set of answers, for the input question.

As mentioned above, QA systems and mechanisms operate by accessing information from a corpus of information (also referred to as a corpus of content), analyzing it, and then generating answer results based on the analysis of this data. Accessing information from a corpus of information typically includes a search that delivers a collection of document links in response to a query against a collection of unstructured data (text, markup language, etc.).

Operating on such content, the QA system generates answers for input questions using a plurality of intensive analysis mechanisms which evaluate the content to identify the most probable answers, i.e. candidate answers, for the input question. The most probable candidate answers are output as a ranked listing of answers ranked according to their relative confidence scores calculated during evaluation of the candidate answers, as a single final answer having a highest ranking confidence score, or a combination of ranked listing and final answer. Typically, alongside each returned answer, the confidence score of that answer is also provided.

FIG. 1 depicts a schematic diagram of one illustrative embodiment of a cognitive system 100 in a computer network 102. The cognitive system 100 is implemented on one or more computing devices 104 (comprising one or more processors and one or more memories, and potentially any other computing device elements generally known in the art including buses, storage devices, communication interfaces, and the like) connected to the computer network 102. The network 102 includes multiple computing devices 104 in communication with each other and with other devices or components via one or more wired and/or wireless data communication links, where each communication link comprises one or more of wires, routers, switches, transmitters, receivers, or the like. The cognitive system 100 and network 102 enables functionality for one or more system trainers via their respective computing devices 110-112. Other embodiments of the cognitive system 100 may be used with components, systems, sub-systems, and/or devices other than those that are depicted herein.

The cognitive system 100 is configured to implement a cognitive system pipeline 108 that receive inputs from various sources. For example, the cognitive system 100 receives input from the network 102, a corpus of information 106, system trainers, and/or other data and other possible sources of input. In one embodiment, some or all of the inputs to the cognitive system 100 are routed through the network 102. The various computing devices 104 on the network 102 include access points for content creators and system trainers. Some of the computing devices 104 include devices for a search index, content repository or database storing the corpus of information 106 (Which is shown as a separate entity in FIG. 1 for illustrative purposes only). Portions of the corpus of information 106 may also be provided on one or more other network attached storage devices, in one or more search indexes, content repositories or databases, or other computing devices not explicitly shown in FIG. 1. The network 102 includes local network connections and remote connections in various embodiments, such that the cognitive system 100 may operate in environments of any size, including local and global, e,g., the Internet.

In one embodiment, the content creator creates content in a document of the corpus of information 106 for use as part of a corpus of information with the cognitive system 100. The document includes any file, text, article, or source of data for use in the cognitive system 100. System trainers access the cognitive system 100 via a network connection or an Internet connection to the network 102, and input questions to the cognitive system 100 that are answered by the content in the corpus of information 106. In one embodiment, the questions are formed using natural language. The cognitive system 100 parses and interprets the question, and provides a response to the system user, e,g., system trainer 110, containing one or more answers to the question. In some embodiments, the cognitive system 100 provides a response to users in a ranked list of candidate answers while in other illustrative embodiments, the cognitive system 100 provides a single final answer or a combination of a final answer and ranked listing of other candidate answers.

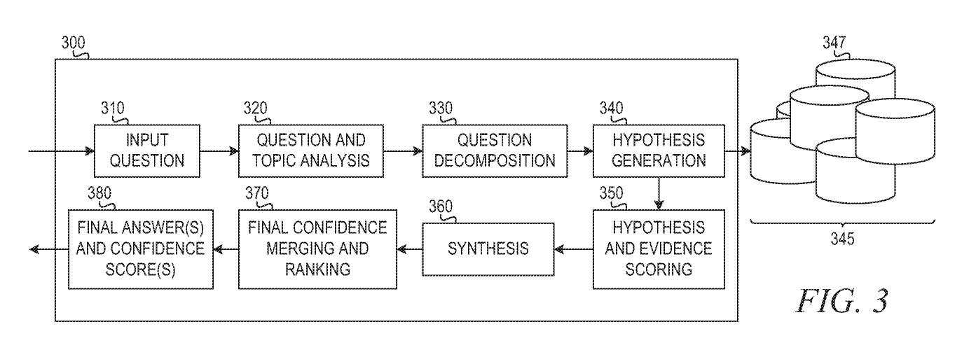

The cognitive system 100 implements a cognitive system pipeline 108 which comprises a plurality of stages for processing an input question and the corpus of information 106. The cognitive system pipeline 108 generates answers for the input question based on the processing of the input question and the corpus of information 106. The cognitive system pipeline 108 will be described in greater detail hereafter with regard to FIG. 3.

In some illustrative embodiments, the cognitive system 100 may be the IBM Watson™ QA system available from International Business Machines Corporation of Armonk, New York, which is augmented with the mechanisms of the illustrative embodiments described hereafter. As outlined previously, the IBM Watson™ QA system receives an input question Which it then parses to extract the major features of the question, which in turn are then used to formulate queries that are applied to the corpus of information. Based on the application of the queries to the corpus of information, a set of hypotheses, or candidate answers to the input question, are generated by looking across the corpus of information for portions of the corpus of information that have some potential for containing a valuable response to the input question. The IBM Watson™ QA system then performs deep analysis on the language of the input question and the language used in each of the portions of the corpus of information found during the application of the queries using a variety of reasoning algorithms. ‘The scores obtained from the various reasoning algorithms are then weighted against a statistical model that summarizes a level of confidence that the IBM Watson™ QA system has regarding the evidence that the potential response, i.e. candidate answer, is inferred by the question. This process is repeated for each of the candidate answers to generate ranked listing of candidate answers which may then be presented to the user that submitted the input question, or from which a final answer is selected and presented to the user. More information about the IBM Watson™ QA system may be obtained, for example, from the IBM Corporation website, IBM Redbooks, and the like. For example, information about the IBM Watson™ QA system can be found in Yuan et al., “Watson and Healthcare,” IBM developerWorks, 2011 and “The Era of Cognitive Systems: An Inside Look at IBM Watson and How it Works” by Rob High, IBM Redbooks, 2012.

FIG. 2 is a block diagram of an example data processing system in which aspects of the illustrative embodiments are implemented. Data processing system 200 is an example of a computer, such as server 104 or client 110 in FIG. 1, in which computer usable code or instructions implementing the processes for illustrative embodiments of the present invention are located. In one illustrative embodiment, FIG. 2 represents a server computing device, such as a server 104, which, which implements a cognitive system 100 and cognitive system pipeline 108 augmented to include the additional mechanisms of the illustrative embodiments described hereafter.

In the depicted example, data processing system 200 employs a hub architecture including north bridge and memory controller hub (NB/MCH) 202 and south bridge and input/output (I/O) controller hub (SB/ICH) 204. Processing unit 206, main memory 208, and graphics processor 210 are connected to NB/MCH 202. Graphics processor 210 is connected to NB/MCH 202 through an accelerated graphics port (AGP).

In the depicted example, local area network (LAN) adapter 212 connects to SB/ICH 204. Audio adapter 216, keyboard and mouse adapter 220, modem 222, read only memory (ROM) 224, hard disk drive (HDD) 226, CD-ROM drive 230, universal serial bus (USB) ports and other communication ports 232, and PCl/PCIe devices 234 connect to SBACH 204 through bus 238 and bus 240. PCl/PCIe devices may include, for example, Ethernet adapters, add-in cards, and PC cards for notebook computers. PCI uses a card bus controller, while PCIe does not. ROM 224 may be, for example, a flash basic input/output system (BIOS).

HDD 226 and CD-ROM drive 230 connect to MICH 204 through bus 240, HDD 226 and CD-ROM drive 230 may use, for example, an integrated drive electronics (IDE) or serial advanced technology attachment (SATA) interface. Super I/O (SK)) device 236 is connected to SIV ICH 204.

An operating system runs on processing unit 206. The operating system coordinates and provides control of various components within the data processing system 200 in FIG. 2. As a client, the operating system is a commercially available operating system such as Microsoft® Windows 8®. An object-oriented programming system, such as the Java™ programming system, may run in conjunction with the operating system and provides calls to the operating system from Java™ programs or applications executing on data processing system 200.

As a server, data processing system 200 may be, for example, an IBM® eServer™ System p® computer system, running the Advanced Interactive Executive (AIX®) operating system or the LINUX® operating system. Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as HDD 226, and are loaded into main memory 208 for execution by processing unit 206. The processes for illustrative embodiments of the present invention are performed by processing unit 206 using computer usable program code, which is located in a memory such as, for example, main memory 208, ROM 224, or in one or more peripheral devices 226 and 230, for example.

A bus system, such as bus 238 or bus 240 as shown in FIG. 2, is comprised of one or more buses. Of course, the bus system may be implemented using any type of communication fabric or architecture that provides for a transfer of data between different components or devices attached to the fabric or architecture. A communication unit, such as modem 222 or network adapter 212 of FIG. 2, includes one or more devices used to transmit and receive data. A memory may be, for example, main memory 208, ROM 224, or a cache such as bound in NB/MCH 202 in FIG. 2,

Those of ordinary skill in the art will appreciate that the hardware depicted in FIGS. 1 and 2 may vary depending on the implementation. Other internal hardware or peripheral devices, such as flash memory, equivalent non-volatile memory, or optical disk drives and the like, may be used in addition to or in place of the hardware depicted in FIGS, 1 and 2. Also, the processes of the illustrative embodiments may be applied to a multiprocessor data processing system, other than the SMP system mentioned previously, without departing from the spirit and scope of the present invention.

Moreover, the data processing system 200 may take the form of any of a number of different data processing systems including client computing devices, server computing devices, a tablet computer, laptop computer, telephone or other communication device, a personal digital assistant (PDA), or the like. In some illustrative examples, data processing system 200 may be a portable computing device that is configured with flash memory to provide non-volatile memory for storing operating system files and/or user-generated data, for example. Essentially, data processing system 200 may be any known or later developed data processing system without architectural limitation.

FIG. 3 illustrates a QA system pipeline for processing an input question in accordance with one illustrative embodiment. The QA system pipeline of FIG. 3 may be implemented, for example, as QA system pipeline 108 of QA system 100 in FIG. 1. It should be appreciated that the stages of the QA system pipeline shown in FIG. 3 are implemented as one or more software engines, components, or the like, which are configured with logic for implementing the functionality attributed to the particular stage. Each stage is implemented using one or more of such software engines, components or the like. The software engines, components, etc. are executed on one or more processors of one or more data processing systems or devices and utilize or operate on data stored in one or more data storage devices, memories, or the like, on one or more of the data processing systems. The QA system pipeline of FIG. 3 is augmented, for example, in one or more of the stages to implement the improved mechanism of the illustrative embodiments described hereafter, additional stages may be provided to implement the improved mechanism, or separate logic from the pipeline 300 may be provided for interfacing with the pipeline 300 and implementing the improved functionality and operations of the illustrative embodiments.

As shown in FIG. 3, the QA system pipeline 300 comprises a plurality of stages 310-380 through which the QA system operates to analyze an input question and generate a final response. In an initial question input stage 310, the QA system receives an input question that is presented in a natural language format. That is, a user inputs, via a user interface, an input question for which the user wishes to obtain an answer, e.g., “Who are Washington's closest advisors?” In response to receiving the input question, the next stage of the QA system pipeline 300, i.e. the question and topic analysis stage 320, parses the input question using natural language processing (NLP) techniques to extract major features from the input question, and classify the major features according to types, e.g., names, dates, or any of a plethora of other defined topics. For example, in the example question above, the term “who” may be associated with a topic for “persons” indicating that the identity of a person is being sought, “Washington” may be identified as a proper name of a person or a location with which the question is associated, “closest” may be identified as a word indicative of proximity or relationship, and “advisors” may be indicative of a type of relationship for the “persons” being sought.

In addition, the extracted major features include key words and phrases classified into question characteristics, such as the focus of the question, the lexical answer type (LAT) of the question, and the like. As referred to herein, a lexical answer type (LAT) is a word in, or a word inferred from, the input question that indicates the type of the answer, independent of assigning semantics to that word. For example, in the question “What maneuver was invented in the 1500s to speed up the game and involves two pieces of the same color?,” the LAT is the string “maneuver.” The focus of a question is the part of the question that, if replaced by the answer, makes the question a standalone statement. For example, in the question “What drug has been shown to relieve the symptoms of ADD with relatively few side effects?” the focus is “drug,” because if this word were replaced with the answer, e.g., the answer “Adderall” can be used to replace the term “drug” to generate the sentence “Adderall has been shown to relieve the symptoms of ADD with relatively few side effects.” The focus often, but not always, contains the LAT. On the other hand, in many cases it is not possible to infer a meaningful LAT from the focus. For example, in the question “What is Java?,” the word “What” does not help to narrow down whether the LAT is a beverage, an island, a sea, or a programming system.

Referring again to FIG. 3, the identified major features are then used during the question decomposition stage 330 to decompose the question into one or more queries that are applied to the corpus of information 345 in order to generate one or more hypotheses. The queries are generated in any known or later developed search API, content repository API, or query language, such as Solr/Lucene, content management interoperability services (CMIS), the Structure Query Language (SQL), or the like. The queries are applied to one or more search indexes, content repositories or databases storing information about the electronic texts, documents, articles, websites, and the like, that make up the corpus of information 345. That is, these various sources themselves, different collections of sources, and the like, represent a different subordinate corpus 347 within the corpus of information 345. There may be different subordinate corpora 347 defined for different collections of documents based on various criteria depending upon the particular implementation. For example, different corpora may be established for different topics, subject matter categories, sources of information, or the like. As one example, a first corpus may he associated with healthcare documents while a second corpus may be associated with financial documents. Alternatively, one corpus may be documents published by the U.S. Department of Energy while another corpus may be IBM Redbooks documents. Any collection of content having some similar attribute may be considered to be a subordinate corpus 347 within the corpus of information 345.

The queries are applied to one or more search indexes, content repositories or databases storing information about the electronic texts, documents, articles, websites, and the like, that make up the corpus of content, e,g., the corpus of information 106 in FIG. 1. The queries are applied to the corpus of information at the hypothesis generation stage 340 to generate results identifying potential hypotheses for answering the input question, which can then be evaluated. That is, the application of the queries results in the extraction of portions of the corpus of information matching the criteria of the particular query. These portions of the corpus are then analyzed and used, during the hypothesis generation stage 340, to generate hypotheses for answering the input question. These hypotheses are also referred to herein as “candidate answers” for the input question. For any input question, at this stage 340, there may be hundreds of hypotheses or candidate answers generated that may need to be evaluated.

The QA system pipeline 300, in stage 350, then performs a deep analysis and comparison of the language of the input question and the language of each hypothesis or “candidate answer,” as well as performs evidence scoring to evaluate the likelihood that, the particular hypothesis is a correct answer for the input question. As mentioned above, this involves using a plurality of reasoning algorithms, each performing a separate type of analysis of the language of the input question and/or content of the corpus that provides evidence in support of, or not in support of, the hypothesis. Each reasoning algorithm generates a score based on the analysis it performs which indicates a measure of relevance of the individual portions of the corpus of information extracted by application of the queries as well as a measure of the correctness of the corresponding hypothesis, i.e. a measure of confidence in the hypothesis. There are various ways of generating such scores depending upon the particular analysis being performed. In generally, however, these algorithms look for particular terms, phrases, or patterns of text that are indicative of terms, phrases, or patterns of interest and determine a degree of matching with higher degrees of matching being given relatively higher scores than lower degrees of matching.

Thus, for example, an algorithm may be configured to look for the exact term from an input question or synonyms to that term in the input question, e.g., the exact term or synonyms for the term “movie,” and generate a score based on a frequency of use of these exact terms or synonyms. In such a case, exact matches will be given the highest scores, while synonyms may be given lower scores based on a relative ranking of the synonyms as may be specified by a subject matter expert (person with knowledge of the particular domain and terminology used) or automatically determined from frequency of use of the synonym in the corpus corresponding to the domain. Thus, for example, an exact match of the term “movie” in content of the corpus (also referred to as evidence, or evidence passages) is given a highest score. A synonym of movie, such as “motion picture” may be given a lower score but still higher than a synonym of the type “film” or “moving picture show.” Instances of the exact matches and synonyms for each evidence passage may be compiled and used in a quantitative function to generate a score for the degree of matching of the evidence passage to the input question.

Thus, for example, a hypothesis or candidate answer to the input question of “What was the first movie?” is “The Horse in Motion.” If the evidence passage contains the statements “The first motion picture ever made was ‘The Horse in Motion’ in 1878 by Eadweard Muybridge. It was a movie of a horse running,” and the algorithm is looking for exact matches or synonyms to the focus of the input question, i.e. “movie,” then an exact match of “movie” is found in the second sentence of the evidence passage and a highly scored synonym to “movie,” i.e. “motion picture,” is found in the first sentence of the evidence passage. This may be combined with further analysis of the evidence passage to identify that the text of the candidate answer is present in the evidence passage as well, i.e. “The Horse in Motion.” These factors may be combined to give this evidence passage a relatively high score as supporting evidence for the candidate answer “The Horse in Motion” being a correct answer.

It should be appreciated that this is just one simple example of how scoring can be performed. Many other algorithms of various complexities may be used to generate scores for candidate answers and evidence without departing from the spirit and scope of the present invention.

In the synthesis stage 360, the large number of scores generated by the various reasoning algorithms are synthesized into confidence scores or confidence measures for the various hypotheses. This process involves applying weights to the various scores, where the weights have been determined through training of the statistical model employed by the QA system and/or dynamically updated. For example, the weights for scores generated by algorithms that identify exactly matching terms and synonym may be set relatively higher than other algorithms that are evaluating publication dates for evidence passages. The weights themselves may be specified by subject matter experts or learned through machine learning processes that evaluate the significance of characteristics evidence passages and their relative importance to overall candidate answer generation.

The weighted scores are processed in accordance with a statistical model generated through training of the QA system that identifies a manner by which these scores may be combined to generate a confidence score or measure for the individual hypotheses or candidate answers. This confidence score or measure summarizes the level of confidence that the QA system has about the evidence that the candidate answer is inferred by the input question, i.e, that the candidate answer is the correct answer for the input question.

The resulting confidence scores or measures are processed by a final confidence merging and ranking stage 370 which compares the confidence scores and measures to each other, compares them against predetermined thresholds, or performs any other analysis on the confidence scores to determine which hypotheses/candidate answers are the most likely to be the correct answer to the input question. The hypotheses/candidate answers are ranked according to these comparisons to generate a ranked listing of hypotheses/candidate answers ‘hereafter simply referred to as “candidate answers”). From the ranked listing of candidate answers, at stage 380, a final answer and confidence score, or final set of answers and confidence scores, are generated and output to the submitter of the original input question via a graphical user interface or other mechanism for outputting information.

An answer could be a passage of text from a document in the corpus, or an answer could be a distinct information particle that is supported by one or more passages of text from documents in the corpus. A question and answer key is a list of pairs, each consisting of a question and a list of answer indicators. Each answer indicator could directly specify a particular passage of a document in the corpus that is an answer to a question, or it could indirectly specify a pattern that is used to identify passages from documents in the corpus that are answers to a question. An example of a direct answer indicator is a document passage identifier, optionally further qualified by a numeric offset and length of a span of text within the passage that gives the answer more precisely. An example of an indirect answer indicator is a regular expression that may match zero, one, or many passages in documents of the corpus, optionally qualified by a secondary span indicator or perhaps a second regular expression that helps to isolate a more precise answer within a given passage. As a third alternative, an answer indicator could express a factoid answer in which the answer is characterized by a text string or a pattern, and the passages from corpus documents that support the answer are characterized by a list of direct references or indirect patterns.

As used herein, the term “ground truth” refers to one or more question and answer keys used for training and testing a QA system. Typically, the questions in the training answer key are distinct from the test answer key. While the training set questions may be distinct from the test set questions, the answer indicators may not be, because the same passage may provide an answer, or evidence for an answer, for more than one question.

Training a machine learning model for a cognitive system, such as a QA system, involves the use of multiple linguistic scorers that rate how a given passage relates to a given question. A simple example of a scorer is one that assigns a score to a passage proportional to the number of words that it has in common with a given question, optionally ignoring words from a list of words known to be unimportant. For each question in the training set, a set of passages from the corpus is obtained and each is scored, relative to the question, with each of K linguistic scorers. One additional score is computed for each passage: whether or not the passage is deemed to be an answer for the question based on analyzing the passage with the question's answer indicator list. A passage is “in the ground truth” for a question if it is matched by the question's answer indicator. In this way, for each question, each passage from the set of passages analyzed becomes a (K+1)-valued data point. One machine learning mechanism for training, then, consists of determining the (K+1)-variable logistic regression model of best lit for the passage data points.

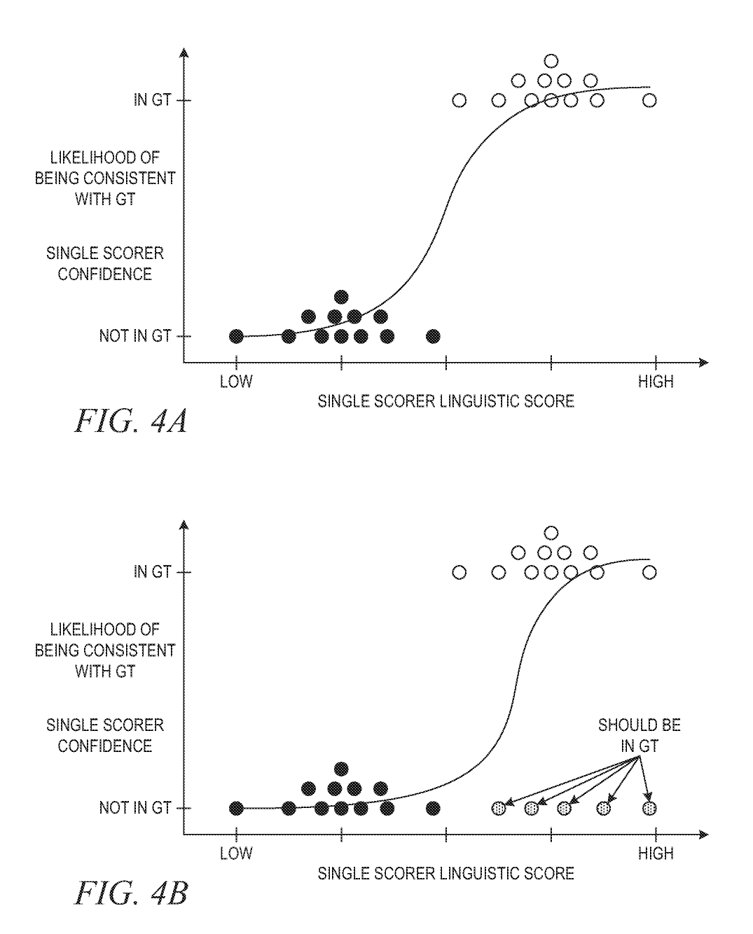

During testing or usage of the cognitive system, the trained model is used to predict the extent to which a given passage is consistent with a ground truth passage that would answer or support an answer for a question. FIG. 4A illustrates a. plot of data points, each representing a question-passage pair, based on a score from one linguistic scorer on the X-axis and the ground truth status on the Y-axis. In. FIG. 4A, the passages that match the answer indicators of the training questions appear vertically high due to being in the ground truth. In this example, they also receive a high score from the linguistic scorer, which is therefore a theoretically optimal scorer for the domain of the questions and corpus. Similarly, the passages that are not in the ground truth because they do not match the answer indicator lists of the questions are depicted vertically low. These passages also receive a low linguistic score from the theoretically optimal linguistic scorer. The S-shaped logistic regression curve that is computed during training is depicted, and it is clear that during testing or usage it would be a very strong predictor (large effect size) of whether or not passage are consistent with the ground truth of questions like those being posed during testing or consistent with good answers for questions posed during usage.

During training, the QA system scores passages relative to questions linguistically with many scorers like the one on the X-axis, and it scores the passages for a given question on membership in ground truth based on matching the answer list of the given question. The training then determines the logistic regression model of best fit to the data points so that the trained model can be used to predict whether similar passages are consistent with the ground truth for similar questions.

The accuracy of the training model's predictions, and hence the quality of the QA system, relies on the logistic regression achieving a large statistical effect size. One factor that can dramatically reduce the efficacy of machine learning model training is if the answer indicator lists of the training questions do not match many passages of the corpus of information that should be in the ground truth because they are good answers to the questions. When this happens, the logistic regression model of best fit is warped by data points that should be vertically high, i.e. in the ground truth, but are vertically low, i.e. not in ground truth. FIG. 4B illustrates a logistic model trained with incorrectly identified passages in accordance with an illustrative embodiment. The additional data points are passages that both are good answers (or are good support for answers) and also are scored high by the theoretically optimal linguistic scorer. As a result of these data points, the regression curve does not rise until it reaches linguistic score values that are much greater than in FIG. 4A. During testing and usage, the resulting QA system would have less confidence that a passage answers a question based on a medium or medium-high linguistic score on the match between the question and the passage.

The current process for ground truth collection is labor intensive and still ends up producing question and answer keys in which many relevant passages for answering questions are not identified, resulting in poor training, lower accuracy, and ultimately reduced quality. The illustrative embodiments provide mechanisms for finding additional relevant passages for answering ground truth questions.

Given a set of representative questions from ground truth training and test sets, the current approach to ground truth answer key completion is for subject matter experts (SMEs) to iterate the following steps:

1) identify search queries that will help find good answers for given questions;

2) use traditional search tools to find passages that help answer the questions and update the answer key accordingly;

3) train the QA system;

4) run a separate “blind set” of questions and look at the answers;

5) using knowledge of the corpus of information, determine if the answers coming from the QA system match the answers expected for the blind set;

6) investigate why certain expected answers are not produced; and,

7) change the QA system configuration as necessary, change domain dictionaries, synonym lists, scorers, etc.

The problem with this approach is that the search tools are not very good at finding all of the relevant passages for answering a question, as this is the very problem that the QA system must overcome. The amount of progress in training per iteration is therefore substantially reduced due to poorer training. This makes the process far more labor intensive for the SMEs.

It is important to note that there are two variations on step 2 above. The first is one in which the passages found by the search tools are directly indicated in the answer key, such as by adding unique identifiers for passages, either as answers or as supporting evidence for answers. The second approach is one in which the user examines the identified passages and develops a regular expression that characterizes the passages.

This latter approach is important to note because the regular expression then becomes an alternative method to just using search tools for finding additional relevant passages that could he used to help answer a question or support an answer to a question. However, there are a number of drawbacks of this approach. First, the filtering expressions must be manually developed by the user. Second, it is based on a technique (regular expressions) that may be arcane to the user. Third, when the regular expression finds additional passages that are inappropriate, the user must manually determine a much more complicated regular expression that continues to accept the desired passages while also rejecting the inappropriate passages. This may be difficult or impossible to do and leads to the fourth drawback, which is that this alternative method is never more powerful than the expressive limitations of regular expressions.

The main idea of the illustrative embodiments is to equip the ground truth collection tooling with an additional mechanism for finding a list of additional relevant passages for any selected question.

The problem of poor QA system training becomes increasingly urgent as corpus size grows, because it becomes increasingly difficult for SMEs to identify enough answers for answer keys to overcome the poor training problem described above. The illustrative embodiments provide mechanisms for obtaining more of the additional relevant passages needed to obtain better training results and reduce the number of iterations of ground truth answer key passage selection.

In accordance with the illustrative embodiments, there are fundamentally two types of answer keys: those in which each answer is a direct passage identifier for a passage that answers or supports an answer for a question and those in which each answer is a characterization of the passages that would be an answer or support an answer to a question. To begin, the illustrative embodiments convert the latter type of answer key into the former.

The approach of the illustrative embodiment would suppress the distinction between a passage that is an answer and a passage that supports an answer. This is because a passage that supports an answer is a support precisely because of its linguistic associations with the question, not:lust the answer being supported. For example, in the question, “Who was elected president in the U.S. in 2008?” the passages that support the answer Barack Obama will, of course, contain tokens like “Barack” and “Obama,” but they will also contain tokens like “president,” “U.S.,” and “2008.”

Hence, the description of the illustrative embodiments focuses on processing question and answer keys that are lists of pairs, where each pair is a question and an answer specification that is an answer indicator list, i.e. a list of identities of passages from the corpus of information. This is referred to herein as a question and passage list answer key.

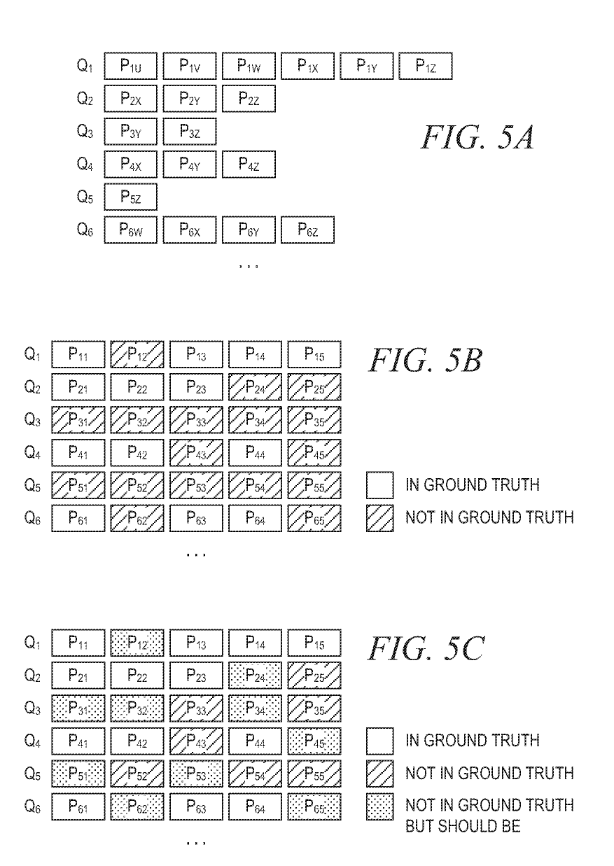

FIG. 5A illustrates an example of a question and passage list answer key in accordance with an illustrative embodiment. Each question has at least one associated passage from the corpus of information. However, the passage lists may have been derived from a QA system answer indicator list that contains direct passage indicators or indirect passage characterizations, such as complex regular expressions.

In one illustrative embodiment, a QA system is trained with the question and answer key depicted in FIG. SA. For illustrative purposes, the questions from the training set are submitted to the trained QA system, and FIG. 5B shows an example of passages collected for each question by the trained QA system. Some of the collected passages are in the ground truth of each question, and some of the passages are not. For example, for question Q₁, passages P₁₁, P₁₃, P₁₄, and P₁₅ were already in the answer key, and passage P₁₂ is found by the QA system but is not in the answer key (ground truth) for question Q₁. If a SME were to analyze the passages returned that were not in the answer key for the respective questions, the SME may determine that some of the answers are additional acceptable answers that should be added to the ground truth. FIG. 5C depicts this scenario. For example, for question Q₂, passage P₂₄ should be added to ground truth but P₂₅ should not.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

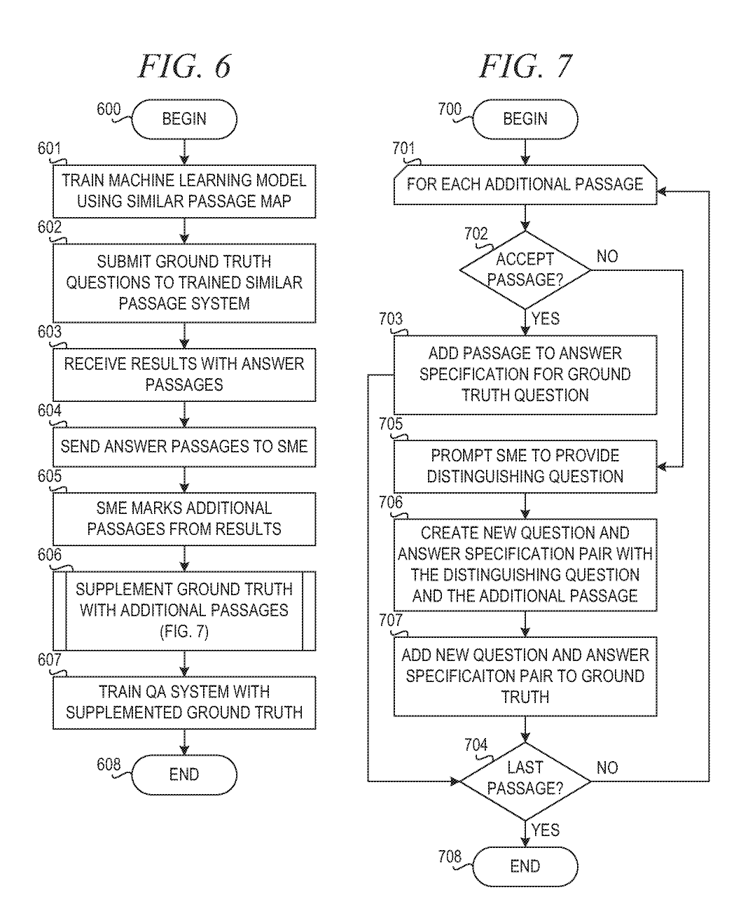

FIG. 6 is a flowchart illustrating operation of a mechanism for using a similar passage system to improve ground truth of a question answering system in accordance with an illustrative embodiment. Operation begins (block 600), and the mechanism trains a machine learning model using a similar passage map (block 601). The resulting similar passage system is a cognitive system operation in accordance with a trained machine learning model. The similar passage system operating in accordance with the trained machine learning model receives input passages and returns a set of similar passages from a corpus of information.

The mechanism submits ground truth questions from a ground truth question and answer key to the trained similar passage system (block 602) and receives results with answer passages (block 603). The mechanism sends the answer passages to a subject matter expert (SME) (block 604). The SME then marks additional answer passages from the results that contain or support a correct answer to the corresponding ground truth question (block 605). The mechanism then supplements the ground truth question and answer key with the additional passages marked by the SME (block 606). The SME marks the additional passages as being accepted (supporting the answer to the ground truth question) or rejected (not supporting the answer to the ground truth question). The operation of supplementing the ground truth question and answer key based on the SME markings is described in further detail below with reference to FIG. 7. The mechanism trains the machine learning model for the QA system using the supplemented ground truth (block 607). Thereafter, operation ends (block 608). The resulting QA system will be more robust and accurate because the machine learning model was trained using improved ground truth.

FIG. 7 is a flowchart illustrating operation of a mechanism for supplementing ground truth based on subject matter expert markings in accordance with an illustrative embodiment. Operation begins for a given ground truth question (block 700), and the mechanism considers each additional passage for a given ground truth question that has been marked by a subject matter expert (SME) (block 701). The mechanism determines whether the additional passage is accepted by the SME (block 702). If the additional passage is accepted by the SME as supporting the answer to the ground truth question, then the mechanism adds the passage to the answer specification for the ground truth question (block 703). Then, the mechanism determines whether the passage is the last passage for the given question (block 704). If the passage is not the last passage, then operation returns to block 701 to consider the next additional passage.

If the additional passage is not accepted by the SME in block 702, i.e., the additional passage is rejected as not supporting the answer to the given ground truth question, then the mechanism prompts the SME to provide a distinguishing question for the additional passage (block 705). The mechanism creates a new question and answer specification pair with the distinguishing question and the additional passage (block 706) and adds the new question and answer specification pair to the ground truth (block 707). Then, the mechanism determines whether the passage is the last passage for the given question (block 704). If the passage is not the last passage, then operation returns to block 701 to consider the next additional passage. If the passage is the last passage for the given ground truth question in block 704, then operation ends (block 708).

This embodiment highlights use of the core embodiment to discover important separator concepts that may not have been represented by the question set. If passages that seem quite similar from a machine learning standpoint are actually not similar based on being an answer to the same question, then improving the question set will improve what the next round of training will he able to learn to differentiate.

In one embodiment, the ground truth entries that do not meet a threshold requirement for the size of the answer indicator list are gathered. The questions of those ground truth entries are presented to a user who, as a subject matter expert, can use knowledge of the corpus of information to find and provide enough references to text passage answers to meet the minimum threshold,

In one example embodiment, the mechanism receives a question and answer pattern key comprising a list of question and answer pattern pairs and converts the question and answer pattern key to the question answer key by resolving each answer pattern to an answer specification comprising a list of references to one or more text passages that match the answer passage from the corpus of information.

In another example embodiment, the mechanism receives a factoid question and answer key comprising a list of question and factoid answer specification pairs. The mechanism converts the factoid question and answer key to the question and answer key by resolving each factoid answer specification to an answer specification comprising a list of references to one or more text passages from the corpus of information.

In one example embodiment, the mechanism automatically triggers the generation of additional relevant passages for at least one question in response to an important event, such as an incremental ingestion/corpus update, an addition of a question to a ground truth training or test set, a request to retain the QA system model, or the deployment of a new model for the QA system.

In another example embodiment, the mechanism automatically updates a “needs review” interface with the additional relevant passages. In yet another example embodiment, the mechanism automatically re-ranks the presentation order of the additional relevant passages in a “needs review” interface according to a text analytical similarity comparison to existing ground truth passages deemed relevant to answering the same question. This embodiment helps reduce the number of passages to be reviewed. Although more passages are generally better than fewer, there would come to a point where under-fitting may occur, at which point extra work would be at best wasted and at worst damaging to the model.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

As noted above, it should be appreciated that the illustrative embodiments may take the form of an entirely hardware embodiment, an entirely software embodiment or an embodiment containing both hardware and software elements. In one example embodiment, the mechanisms of the illustrative embodiments are implemented in software or program code, which includes but is not limited to firmware, resident software, microcode, etc.

A data processing system suitable fir storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art without departing from the scope and spirit of the described embodiments. The embodiment was chosen and described in order to best explain the principles of the invention, the practical application, and to enable others of ordinary skill in the art to understand the invention for various embodiments with various modifications as are suited to the particular use contemplated. The terminology used herein was chosen to best explain the principles of the embodiments, the practical application or technical improvement over technologies found in the marketplace, or to enable others of ordinary skill in the art to understand the embodiments disclosed herein.

1. A method, in a data processing system comprising at least one processor and a memory comprising instructions which, when executed by the at least one processor, causes the at least one processor to improve ground truth in a question answering cognitive system, the method comprising:
training by the data processing system, a similar passage machine learning model for a similar passage cognitive system using a question and answer key to form a trained similar passage machine learning model, wherein the question and answer key comprises a list of question and answer specification pairs forming a ground truth for a question answering cognitive system, wherein each question is a text string and each answer specification references one or more text passages from a corpus of information;
responsive to a search event, sending at least one text input to the similar passage cognitive system operating in accordance with the trained similar passage machine learning model and executing on the at least one processor of the data processing system, wherein the text input comprises a given text passage from a given answer specification of the question and answer key, and receiving from the similar passage cognitive system configured with the trained similar passage machine learning model a response list of references to text passages from the corpus of information that are similar to the given text input;
responsive to an acceptance event for at least one text passage from the response list, supplementing, by the data processing system, the question and answer key by adding the at least one text passage to the given answer specification to form a supplemented question and answer key; and
training a question answering machine learning model of the data processing system using the supplemented question and answer key such that the question answering cognitive system operates in accordance with the trained question answering machine learning model and executes on the at least one processor of the data processing system.

2. The method of claim 1, further comprising:
responsive to a rejection event for a given text passage from the response list, prompting a user to provide a distinguishing question;
creating a new question and answer specification pair, wherein the new question and answer specification pair comprises the distinguishing question and an answer specification that references the given text passage; and
adding the new question and answer specification pair to the question and answer key to form a supplemented question and answer key.

3. The method of claim 1, further comprising:
determining a question and answer specification pair for which the number of text passage references in the answer specification is less than a threshold value;
prompting a user to provide at least one additional text passage reference; and
amending the answer specification to include the at least one additional text passage reference.

4. The method of claim 1, further comprising:
receiving a question and answer pattern key comprising a list of question and answer pattern pairs; and
converting the question and answer pattern key to the question and answer key by resolving each answer pattern to an answer specification comprising a list of references to one or more text passages that match the answer pattern from the corpus of information.

5. The method of claim 1, further comprising:
receiving a factoid question and answer key comprising a list of question and factoid answer specification pairs; and
converting the factoid question and answer key to the question and answer key by resolving each factoid answer specification to an answer specification comprising a list of references to one or more text passages from the corpus of information.

6. The method of claim 1, further comprising automatically generating at least one search event upon completion of an ingestion operation that updates the corpus of information.

7. The method of claim 1, further comprising:
invoking at least one search event for at least one text passage of the question and answer key; and
populating a user interface with at least one response list received from the at least one search event.

8. The method of claim 7, wherein populating a user interface with at least one response list further comprises reordering the response list according to a text analytical proximity measure for each text passage in the response list relative to the text input sent to the search event that returned the response list.

9. A computer program product comprising a computer readable storage medium having a computer readable program stored therein, wherein the computer readable program, when executed on a computing device, causes the computing device to improve ground truth in a question answering cognitive system, wherein the computer readable program causes the computing device to:
train, by the computing device, a similar passage machine learning model for a similar passage cognitive system using a question and answer key to form a trained similar passage machine learning model, wherein the question and answer key comprises a list of question and answer specification pairs forming a ground truth for a question answering cognitive system, wherein each question is a text string and each answer specification references one or more text passages from a corpus of information;
responsive to a search event, send at least one text input to the similar passage cognitive system operating in accordance with the trained similar passage machine learning model and executing on the at least one processor of the computing device, wherein the text input comprises a given text passage from a given answer specification of the question and answer key, and receive from the similar passage cognitive system configured with the trained similar passage machine learning model a response list of references to text passages from the corpus of information that are similar to the given text input;
responsive to an acceptance event for at least one text passage from the response list, supplement, by the computing device., the question and answer key by adding the at least one text passage to the given answer specification to form a supplemented question and answer key; and
train a question answering machine learning model of the data processing system using the supplemented question and answer key such that the question answering cognitive system operates in accordance with the trained question answering machine learning model and executes on the at least one processor of the computing device.

10. The computer program product of claim 9, wherein the computer readable program further causes the computing device to:
responsive to a rejection event for a given text passage from the response list, prompt a user to provide a distinguishing question;
create a new question and answer specification pair, wherein the new question and answer specification pair comprises the distinguishing question and an answer specification that references the given text passage; and
add the new question and answer specification pair to the question and answer key to form a supplemented question and answer key.

11. The computer program product of claim 9, wherein the computer readable program further causes the computing device to:
receive a question and answer pattern key comprising a list of question and answer pattern pairs; and
convert the question and answer pattern key to the question and answer key by resolving each answer pattern to an answer specification comprising a list of references to one or more text passages that match the answer pattern from the corpus of information.

12. The computer program product of claim 9, wherein the computer readable program further causes the computing device to:
receive a factoid question and answer key comprising a list of question and factoid answer specification pairs; and
convert the factoid question and answer key to the question and answer key by resolving each factoid answer specification to an answer specification comprising a list of references to one or more text passages from the corpus of information.

13. The computer program product of claim 9, wherein the computer readable program further causes the computing device to automatically generate at least one search event upon completion of an ingestion operation that updates the corpus of information.

14. The computer program product of claim 9, wherein the computer readable program further causes the computing device to:
invoke at least one search event for at least one text passage of the question and answer key; and
populate a user interface with at least one response list received from the at least one search event.

15. The computer program product of claim 14, wherein populating a user interface with at least one response list further comprises reordering the response list according to a text analytical proximity measure for each text passage in the response list relative to the text passage sent to the search event that returned the response list.

16. An apparatus comprising:
a processor; and
a memory coupled to the processor, wherein the memory comprises instructions which, when executed by the processor, cause the processor to improve ground truth in a question answering cognitive system, wherein the instructions causes the processor to:
train a similar passage machine learning model for a similar passage cognitive system using a question and answer key to form a trained similar passage machine learning model, wherein the question and answer key comprises a list of question and answer specification pairs forming a ground truth for a question answering cognitive system, wherein each question is a text string and each answer specification references one or more text passages from a corpus of information;
responsive to a search event, send at least one text input to the similar passage cognitive system operating in accordance with the trained similar passage machine learning model and executing on the processor, wherein the text input comprises a given text passage from a given answer specification of the question and answer key, and receive from the similar passage cognitive system configured with the trained similar passage machine learning model a response list of references to text passages from the corpus of information that are similar to the given text input;
responsive to an acceptance event for at least one text passage from the response list, supplement the question and answer key by adding the at least one text passage to the given answer specification to form a supplemented question and answer key; and
train a question answering machine learning model of the data processing system using the supplemented question and answer key such that the question answering cognitive system operates in accordance with the trained question answering machine learning model.

17. The apparatus of claim 16, wherein the instructions further causes the processor to:
responsive to a rejection event for a given text passage from the response list, prompt a user to provide a distinguishing question;
create a new question and answer specification pair, wherein the new question and answer specification pair comprises the distinguishing question and an answer specification that references the given text passage; and
add the new question and answer specification pair to the question and answer key to form a supplemented question and answer key.

18. The apparatus of claim 16, wherein the instructions further causes the processor to:
receive a question and answer pattern key comprising a list of question and answer pattern pairs; and
convert the question and answer pattern key to the question and answer key by resolving each answer pattern to an answer specification comprising a list of references to one or more text passages that match the answer pattern from the corpus of information.

19. The apparatus of claim 16, wherein the instructions further causes the processor to:
receive a question and answer pattern key comprising a list of question and answer pattern pairs; and
convert the question and answer pattern key to the question and answer key by resolving each answer pattern to an answer specification comprising a list of references to one or more text passages that match the answer pattern from the corpus of information.

20. The apparatus of claim 16, wherein the instructions further causes the processor to automatically generate at least one search event upon completion of an ingestion operation that updates the corpus of information.

21. The apparatus of claim 16, wherein the instructions further causes the processor to:
invoke at least one search event for at least one text passage of the question and answer key; and
populate a user interface with at least one response list received from the at least one search event.

22. The apparatus of claim 21, wherein populating a user interface with at least one response list further comprises reordering the response list according to a text analytical proximity measure for each text passage in the response list relative to the text passage sent to the search event that returned the response list.
